(19) United States
(12) Patent Application Publication
(10) Pub. No.: US 2026/0355861 A1
(43) Pub. Date: Nov. 12, 2026

(54) INTELLIGENT LASER WELDING SYSTEM WITH ADAPTIVE GROOVE CREATION

(71) Applicant: International Business Machines Corporation, Armonk, NY (US)

(72) Inventors: Sarbajit Kumar Rakshit, Kolkata (IN); Sathya Santhar, Ramapuram (IN); Sridevi Kannan, Chennai (IN)

(21) Appl. No.: 19/200,170

(22) Filed: May 6, 2025

(51) Int. Cl. B23K 26/24; B23K 26/03; B23K 26/08; B23K 26/38; B23K 26/70

(52) U.S. Cl. CPC B23K 26/24; B23K 26/034; B23K 26/0869; B23K 26/38; B23K 26/702

(57) ABSTRACT

According to one embodiment, a method, computer system, and computer program product for distributed edge resilience enhancement is provided. The embodiment may include identifying a crack in a work product. The embodiment may also include identifying a groove design associated with a welding repair of the crack based on an analysis of the crack and the work product. The embodiment may further include generating a groove based on the grove design using a laser cutting system. The embodiment may also include performing the welding repair within the generated groove using a laser welding system.

### BACKGROUND

The present invention relates generally to the field of computing, and more particularly to laser welding systems.

Laser welding is a high-energy beam welding process that uses a focused laser to melt and join materials. This technique utilizes the intense heat generated by a concentrated laser beam to create a weld pool, allowing for precise and localized heating of the workpieces. The laser beam can be delivered through fiber optics or mirrors, enabling flexibility in welding configurations and automation.

Laser welding finds applications across various industries including automotive manufacturing, aerospace, electronics, and medical device production. In the automotive sector, laser welding is used for joining body panels, frame components, and powertrain parts. Aerospace applications include welding of turbine components, fuel systems, and structural elements. The electronics industry employs laser welding for connecting small, delicate components in devices like smartphones and computers. Medical device manufacturers utilize laser welding for creating hermetic seals in implantable devices and joining dissimilar materials in surgical instruments.

The development of laser welding technology has progressed significantly since its introduction in the 1960s. Advancements in laser sources, beam delivery systems, and process control have expanded the capabilities of laser welding. Modern laser welding systems incorporate features such as real-time monitoring, adaptive control, and integration with robotic systems. These developments have contributed to increased welding speeds, improved weld quality, and enhanced process reliability across a wide range of materials and applications.

### SUMMARY

According to one embodiment, a method, computer system, and computer program product for distributed edge resilience enhancement is provided. The embodiment may include identifying a crack in a work product. The embodiment may also include identifying a groove design associated with a welding repair of the crack based on an analysis of the crack and the work product. The embodiment may further include generating a groove based on the grove design using a laser cutting system. The embodiment may also include performing the welding repair within the generated groove using a laser welding system.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates functional block diagram of components for an intelligent laser welding system according to at least one embodiment.

FIG. 3 illustrates an operational flowchart for an intelligent laser welding process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to the laser welding systems. The following described exemplary embodiments provide a system, method, and program product to, among other things, utilize visual analysis and machine learning techniques to identify cracks, determine appropriate groove designs, create grooves using laser cutting, and perform adaptive welding repairs on workpieces. Therefore, the present embodiment has the capacity to improve the technical field of laser welding systems by incorporating adaptive groove creation capabilities, where the system uses visual analysis and machine learning techniques to automatically identify cracks, determine optimal groove designs, and create customized grooves using laser cutting before performing the welding repair, thereby enhancing the precision and effectiveness of the welding process for various workpieces.

As previously described, laser welding is a high-energy beam welding process that uses a focused laser to melt and join materials. This technique utilizes the intense heat generated by a concentrated laser beam to create a weld pool, allowing for precise and localized heating of the workpieces. The laser beam can be delivered through fiber optics or mirrors, enabling flexibility in welding configurations and automation.

Laser welding finds applications across various industries including automotive manufacturing, aerospace, electronics, and medical device production. In the automotive sector, laser welding is used for joining body panels, frame components, and powertrain parts. Aerospace applications include welding of turbine components, fuel systems, and structural elements. The electronics industry employs laser welding for connecting small, delicate components in devices like smartphones and computers. Medical device manufacturers utilize laser welding for creating hermetic seals in implantable devices and joining dissimilar materials in surgical instruments.

The development of laser welding technology has progressed significantly since its introduction in the 1960s. Advancements in laser sources, beam delivery systems, and process control have expanded the capabilities of laser welding. Modern laser welding systems incorporate features such as real-time monitoring, adaptive control, and integration with robotic systems. These developments have contributed to increased welding speeds, improved weld quality, and enhanced process reliability across a wide range of materials and applications.

Existing laser welding systems often require manual inspection and preparation of welding areas, which can be time-consuming and may lead to inconsistencies. As such, it may be advantageous to, among other things, utilize an artificial intelligence-reinforced laser welding system to perform crack detection, groove design, and groove creation, thereby improving efficiency and precision in laser welding repairs across various workpieces and materials.

According to at least one embodiment, an intelligent laser welding program introduces an approach to automated welding repair by integrating visual analysis, machine learning, and adaptive groove creation capabilities. The intelligent laser welding program employs advanced object detection technology, such as YOLO (You-Only-Look-Once), to identify cracks in workpieces with high precision. The intelligent laser welding system then utilizes a Generative Adversarial Network (GAN) to determine optimal groove designs based on the specific characteristics of the detected crack, material properties, and strength requirements. The intelligent laser welding program may create customized grooves using laser cutting technology, preparing the workpiece for welding without manual intervention. This adaptive process may ensure that each repair is tailored to the specific needs of the workpiece, improving weld quality and efficiency of a wide range of materials and applications. By combining these cutting-edge technologies, the intelligent laser welding program may significantly enhance the automation, precision, and versatility of laser welding systems, addressing the limitations of traditional manual inspection and preparation.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine-readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

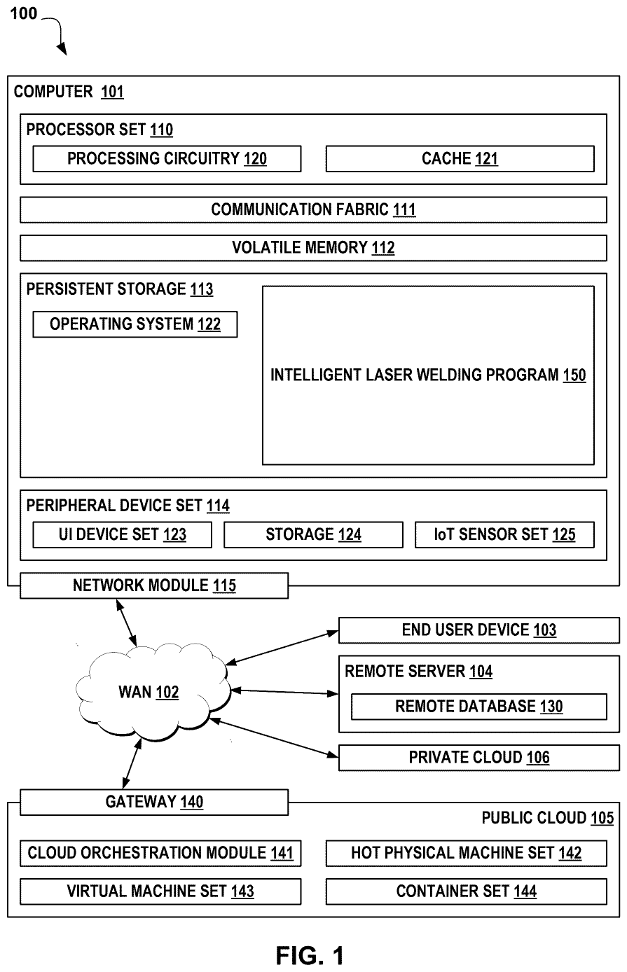

Referring now to FIG. 1, computing environment 100 contains an example of an environment for the execution of at least some of the computer code involved in performing the inventive methods, such as intelligent laser welding program 150. In addition to intelligent laser welding program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and intelligent laser welding program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in intelligent laser welding program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in intelligent laser welding program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

EUD 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to at least one embodiment, the intelligent laser welding program 150 may identify and analyze a crack, fissure, or any other type of welding-repairable deformity to a work product that has formed in the work product, such as a machine part, using IoT sensor set 125. The intelligent laser welding program 150 may then use a generative adversarial network (GAN) to identify the appropriate groove design when creating a weld to repair the crack. Once identified, the intelligent laser welding program 150 may create the groove and perform the welding operation.

In one or more embodiments, the intelligent laser welding program 150 may be communicatively coupled with a laser cutting system, a laser welding system, and/or a laser cleaning system 212. In one or more other embodiments, the laser cutting system, the laser welding system, and the laser cleaning system 212 may be a combined system, and may also be operated through a robotic arm. When the intelligent laser welding program 150 controls the laser cutting system and/or the laser cleaning system 212, the intelligent laser welding program 150 may control a power variation in the laser beam, in a collaborative manner, during the laser cutting and laser welding processes while those processes are performed by different autonomous machines. Dynamic speed control optimizes power consumption throughout the cleaning, cutting, and welding processes, ensuring efficiency and cost-effectiveness.

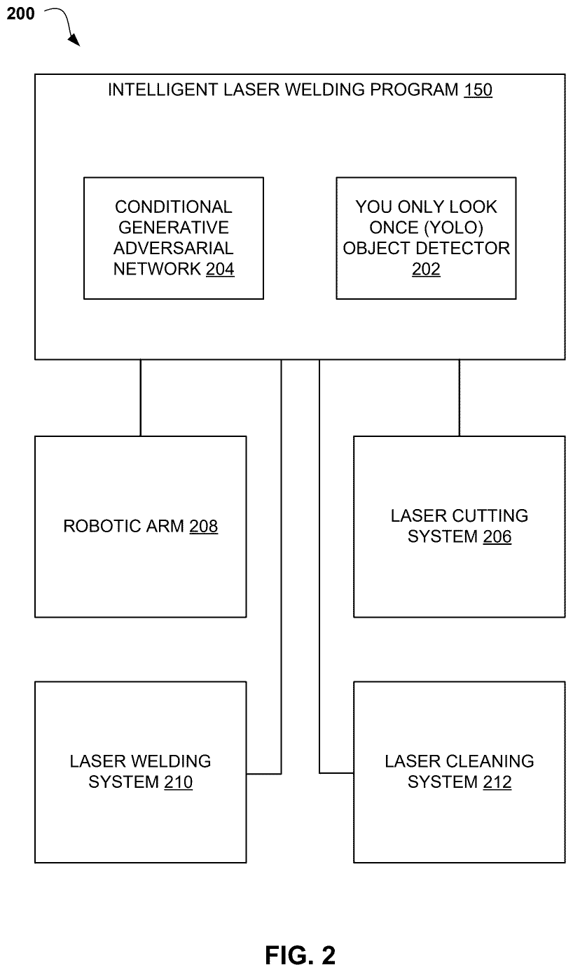

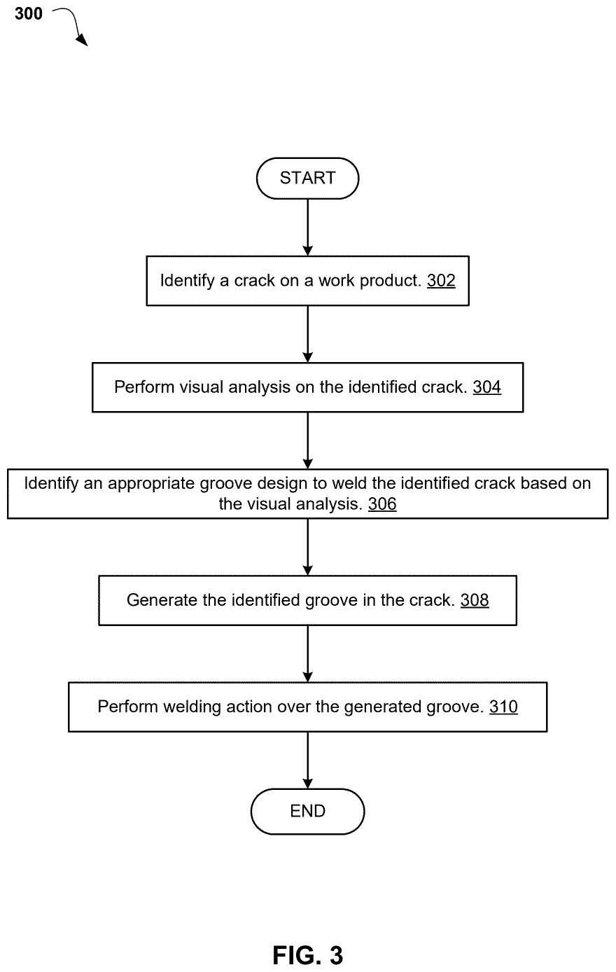

Additionally, prior to initially performing any actions, the intelligent laser welding program 150 may perform an opt-in procedure. The opt-in procedure may include a notification of the data the intelligent laser welding program 150 and may capture the purpose for which that data may be utilized by the intelligent laser welding program 150 during data gathering and operation. Furthermore, notwithstanding depiction in computer 101, the intelligent laser welding program 150 may be stored in and/or executed by, individually or in any combination, EUD 103, remote server 104, public cloud 105, and private cloud 106. The intelligent laser welding method is explained in more detail below with respect to FIGS. 2 and 3.

Referring now to FIG. 2, a functional block diagram 200 of components for an intelligent laser welding system is depicted, according to at least one embodiment. The intelligent laser welding program 150 may integrate YOLO object detection for locating metal cracks and predicting groove specifications, a conditional GAN (cGAN) 204 to generate realistic grooves based on predicted parameters, and a laser cutting system 206 for precise groove creation and subsequent welding by a robotic arm 208 capable of movement in and around the work area of the crack. The YOLO object detector 202 may rely on a convolutional neural network (CNN) for crack detection and groove prediction, the cGAN 204 may leverage a conditional architecture for realistic groove generation, and the laser cutting system 206 may integrate these outputs for precise adaptive metal correction. This collaborative approach optimizes power consumption and ensures efficient correction of cracked metal in a sophisticated synergy of neural networks and laser technology for advanced manufacturing and repair operations.

The YOLO object detector 202 may be employed for crack detection and groove prediction in high-resolution images. The YOLO object detector 202 may include a CNN designed with multiple convolutional layers, followed by fully connected layers. The architecture of the CNN utilized by the YOLO object detector 202 may enable simultaneous detection of objects within an image by dividing it into a gride and predicting bounding boxes and class probabilities for each grid cell. Additionally, the YOLO object detector 202 may be trained on a dataset that includes high-resolution images of cracked metal along with corresponding annotations specifying crack locations and characteristics. Trained on material specifications, the YOLO object detector 202 may precisely locate metal cracks and predict groove types, depths, and angles for subsequent repair operations.

The cGAN 204 may be utilized for realistic groove generation. A cGAN 204 is a type of GAN that incorporates conditional information during the generative process. The cGAN 204 may include a generator network and a discriminator network. The generator network may generate realistic grooves based on conditional information and the discriminator network may evaluate the generated grooves against real grooves. Conditioned on material specifications and the groove predictions of the YOLO object detector 202, the cGAN 204 may generate diverse and realistic groove designs.

During training, the cGAN 204 may learn to generate grooved conditioned on material specifications and groove parameters predicted by the YOLO object detector 202. This learning may enable the cGAN 204 to produce diverse and realistic groove designs suitable for the repair operation. Thus, the cGAN 204 may serve as input to the laser cutting system 206, ensuring the actual groove creation aligns with predicted specifications.

The laser cutting system 206 may be designed to interface with the outputs of the YOLO object detector 202 and the cGAN 204. The laser cutting system 206 may process the groove specifications predicted by the YOLO object detector 202 and the realistic groove designs generated by the cGAN 204. After receiving realistic groove designs, the laser cutting system 206 executes precise cutting based on the predicted groove configurations.

The laser welding system 210 may be designed to interface with the intelligent laser welding program 150 to join or fuse materials together using heat to melt materials together in a bond. In one or more embodiments, laser welding system 210 and laser cutting system 206 may be combined into a joint system that is performed through robotic arm 208.

The laser cleaning system 212 may utilize a laser beam to remove debris detrimental to the welding process performed by the laser welding system 210 or the laser cutting system 206 at any point in the workflow to repair the identified crack. For example, the laser cleaning system 212 may remove rust from a work surface prior to groove creation by the laser cutting system 206 but may also remove debris generated by groove creation prior to welding by the laser welding system 210.

In one or more embodiments, the intelligent laser welding program 150 may include the YOLO object detector 202 and the cGAN 204 installed and the laser cutting system 206, the robotic arm 208, and the laser welding system 210 may be communicatively coupled to receive input instructions from the intelligent laser welding program 150. Despite being depicted as separate entities and communicatively coupled to the intelligent laser welding program 150, the laser cleaning system 212, the laser cutting system 206, and the laser welding system 210 may all be integrated into one system or device or multiple systems or devices performing one or more tasks combined or individually.

Referring now to FIG. 3, an operational flowchart for an intelligent laser welding process 300 is depicted according to at least one embodiment. At 302, the intelligent laser welding program 150 identifies a crack in a work product. The intelligent laser welding program 150 may utilize the YOLO object detector 202 to analyze the work area and identify a crack in the surface that is in need of repair through welding processes. The intelligent laser welding program 150 may capture an image of the work area and annotate the image accordingly, such as by placing a tag or highlighting the identified crack in need of repair.

Then, at 304, the intelligent laser welding program 150 performs visual analysis on the identified crack. Once the intelligent laser welding program 150 has identified the crack, the intelligent laser welding program 150 may further analyze the work area containing the crack using real time data collection and analysis, including the crack parameters, to identify the proper welding repair procedure. The intelligent laser welding program 150 may analyze the area in and around the identified crack, the available spaces, dimensions (e.g., work area thickness, length, width, etc.), required weld penetration, proper filler material. The intelligent laser welding program 150 may also identify various accessibility characteristics to the work area to allow for adequate movement of the laser welding system 210, laser cutting system 206, and robotic arm 208, such as obstacles, blocking, available spaces, and dimensions of available spaces.

The intelligent laser welding program 150 may utilize computer vision while considering dimensions and the capabilities of the laser welding system 210. The intelligent laser welding program 150 may create a virtual representation of the work area to simulate the movement and accessibility of the laser welding system 210 and how the laser cutting system 206 can create grooving of the crack at the welding location. Additionally, the intelligent laser welding program 150 may consider visual analysis results and simulate the movement and position of the laser cutting system 206 for cleaning and grooving of the identified crack.

In one or more embodiments, the intelligent laser welding program 150 may also determine whether cleaning is required before and/or after groove creation is performed based on the real time data collection. The intelligent laser welding program 150 may utilize machine learning algorithms for collaborative decision-making in the cleaning determinations.

Next, at 306, the intelligent laser welding program 150 identifies an appropriate groove design to weld the identified crack based on the visual analysis. The intelligent laser welding program 150, using the results of the visual analysis, may identify grooving types and depths available for the laser cutting system 206 to generate a groove in the identified crack in preparation for welding repair. The groove type may include, but is not limited to, single V, double V, single U, double U, single J, double J, square, bevel, double bevel, flare bevel, or flare V. The groove may also vary in depth to be either full penetration or partial penetration of the crack and/or work area.

The intelligent laser welding program 150 may also utilize a knowledge corpus of usages, depths, and advantages of various grooving types for different types of welding, accessibilities, and strength requirements. Based on the knowledge corpus and the crack location, the intelligent laser welding program 150 may select an appropriate type and depth of grooving required for welding as well as determine whether laser cleaning by the laser cleaning system 212 is also required prior to groove generation within the identified crack.

Based on historical data, the intelligent laser welding program 150 may also train a

GAN, such as cGAN 204, to generate groove designs based on input parameters, such as, but not limited to, material specifications, laser cutting capabilities, and required penetration for welding. Furthermore, the intelligent laser welding program 150 may receive user input for material specifications, workplace accessibility for the laser cutting system 206, the laser welding system 210, and the robotic arm 208, and other parameters while facilitating user input for the GAN-based groove design process.

Once trained, the intelligent laser welding program 150 may transfer the GAN-generated groove design to the laser cutting system 206 and may establish a seamless connection between the GAN-based design system and the laser cutting system 206 to transfer groove design specifications. Subsequently, the intelligent laser welding program 150 may instruct the laser cutting system 206 to execute the groove creation process within the identified crack in the material work area based on the GAN-generated groove design.

Then, at 308, the intelligent laser welding program 150 generates the identified groove in the crack. Prior to generating the identified groove, the intelligent laser welding program 150 may determine a beam strength to be used by the laser cutting system 206. The intelligent laser welding program 150 may perform groove generation within the identified crack using the determined beam strength with the laser cutting system 206. The intelligent laser welding program 150 may control and coordinate the action with the laser cutting system 206 and the laser welding system 210 in step 310

In one or more embodiments, the intelligent laser welding program 150 may generate a workflow of execution of various steps for repairing the identified crack. For example, the intelligent laser welding program 150 may determine a specific grooving type and depth requires laser cleaning and welding at a specific temperature. The intelligent laser welding program 150 may also integrate a collaborative system that enables synchronization of cleaning, cutting, and welding speeds. As such, the intelligent laser welding program 150 may integrate a speed control mechanism to ensure optimal power consumption during the cleaning, cutting, and welding processes.

Next, at 310, the intelligent laser welding program 150 performs a welding action over the generated groove. The intelligent laser welding program 150 may utilize the robotic arm 208, with the laser welding system 210, to perform welding of the work area within the generated groove. The intelligent laser welding program 150 may perform the welding operation when a work area temperature aligns with a preconfigured temperature suitable for welding and continue the welding operation until the entire grooved area is welded and the crack is filled.

When performing the welding operation, the robotic arm 208 may apply filler material around the groove location in order to fill the groove during welding, and supply additional filler material as welding, with the laser welding system 210, performs welding.

During the welding operation in step 310 and cutting/grooving operation in step 308, the intelligent laser welding program 150 may monitor work area temperature gradients to determine how much heat is generated by the laser cutting system 206 and the laser welding system 210. If the intelligent laser welding program 150 determines the heat generated exceeds a preconfigured threshold, the intelligent laser welding program 150 may instruct the laser cutting system 206 and/or the laser welding system 210 to pause operation until the excess heat dissipates below (e.g., satisfies) the preconfigured threshold or a lower cooling threshold.

It may be appreciated that FIGS. 2 and 3 provide only an illustration of one implementation and do not imply any limitations with regard to how different embodiments may be implemented. Many modifications to the depicted environments may be made based on design and implementation requirements. For example, in one or more embodiments, the intelligent laser welding program 150 may identify, in real time, how much heat is generated during different types of laser operation, such as cleaning, cutting, and welding, what activities are to be performed that may result in excessive or insufficient heat generation, and how such activities may be modified to return heat levels to satisfactory levels. In response to heat being generated above a preconfigured threshold, the intelligent laser welding program 150 may alter the generated workflow or a speed control mechanism or power consumption of the laser cleaning system 212, laser cutting system 206, or laser welding system 210 accordingly to allow for adequate heat dissipation. For example, allowing the work product to cool between steps of cleaning, cutting, and welding or pausing operation for a certain period of time. Conversely, the intelligent laser welding program 150 may determine heat needs to be applied to maintain adequate temperature for a certain operation, such as welding. Therefore, the intelligent laser welding program 150 may pause operation if the temperature drops below a preconfigured threshold to allow for application of heat to the work area to raise the temperature above the preconfigured threshold.

In one or more other embodiments, the intelligent laser welding program 150 may gather data regarding each cleaning, cutting, and welding operation performed in order to build a historical knowledge corpus of previous intelligent laser welding program 150 instances. The intelligent laser welding program 150 may utilize this knowledge corpus to improve groove selection, groove depth, cleaning actions, welding actions, and temperature maintenance during operation. Additionally, the intelligent laser welding program 150 may monitor real time heat availability around the work area and dynamically adjust beam power during the welding operation based on historical data and real-time feedback being observed through sensors, such as IoT sensor set 125.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, the method comprising:
identifying a crack in a work product;
identifying a groove design associated with a welding repair of the crack based on an analysis of the crack and the work product;
generating a groove based on the groove design using a laser cutting system; and
performing the welding repair within the generated groove using a laser welding system.

2. The method of claim 1, wherein the analysis further comprises a conditional generative adversarial network to generate realistic grooves in the crack based on conditional information and evaluate the generated grooves against real grooves within a knowledge corpus.

3. The method of claim 1, wherein the laser cutting system and the laser welding system are integrated into a robotic arm.

4. The method of claim 1, further comprising:
performing a cleaning of the generated groove and the work product using a laser cleaning system.

5. The method of claim 1, wherein identifying the crack is performed by a you-only-look-once object detector.

6. The method of claim 1, further comprising:
generating an execution workflow based on the identified groove design, wherein the execution workflow is collaboratively utilized by the laser cutting system, the laser welding system, and a laser cleaning system;
monitoring, in real time, a temperature gradient of the work product; and
in response to the temperature gradient satisfying a threshold, modifying a speed control mechanism and/or power consumption of the laser cutting system, the laser welding system, or a laser cleaning system.

7. The method of claim 1, wherein generating the groove and performing the welding repair utilize dynamic speed controls.

8. A computer system, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
identifying a crack in a work product;
identifying a groove design associated with a welding repair of the crack based on an analysis of the crack and the work product;
generating a groove based on the groove design using a laser cutting system; and
performing the welding repair within the generated groove using a laser welding system.

9. The computer system of claim 8, wherein the analysis further comprises a conditional generative adversarial network to generate realistic grooves in the crack based on conditional information and evaluate the generated grooves against real grooves within a knowledge corpus.

10. The computer system of claim 8, wherein the laser cutting system and the laser welding system are integrated into a robotic arm.

11. The computer system of claim 8, further comprising:
performing a cleaning of the generated groove and the work product using a laser cleaning system.

12. The computer system of claim 8, wherein identifying the crack is performed by a you-only-look-once object detector.

13. The computer system of claim 8, further comprising:
generating an execution workflow based on the identified groove design, wherein the execution workflow is collaboratively utilized by the laser cutting system, the laser welding system, and a laser cleaning system;
monitoring, in real time, a temperature gradient of the work product; and
in response to the temperature gradient satisfying a threshold, modifying a speed control mechanism and/or power consumption of the laser cutting system, the laser welding system, or a laser cleaning system.

14. The computer system of claim 8, wherein generating the groove and performing the welding repair utilize dynamic speed controls.

15. A computer program product, the computer program product comprising:
one or more computer-readable tangible storage media and program instructions stored on at least one of the one or more tangible storage media, the program instructions executable by a processor capable of performing a method, the method comprising:
identifying a crack in a work product;
identifying a groove design associated with a welding repair of the crack based on an analysis of the crack and the work product;
generating a groove based on the groove design using a laser cutting system; and
performing the welding repair within the generated groove using a laser welding system.

16. The computer program product of claim 15, wherein the analysis further comprises a conditional generative adversarial network to generate realistic grooves in the crack based on conditional information and evaluate the generated grooves against real grooves within a knowledge corpus.

17. The computer program product of claim 15, wherein the laser cutting system and the laser welding system are integrated into a robotic arm.

18. The computer program product of claim 15, further comprising:
performing a cleaning of the generated groove and the work product using a laser cleaning system.

19. The computer program product of claim 15, wherein identifying the crack is performed by a you-only-look-once object detector.

20. The computer program product of claim 15, further comprising:
generating an execution workflow based on the identified groove design, wherein the execution workflow is collaboratively utilized by the laser cutting system, the laser welding system, and a laser cleaning system;
monitoring, in real time, a temperature gradient of the work product; and
in response to the temperature gradient satisfying a threshold, modifying a speed control mechanism and/or power consumption of the laser cutting system, the laser welding system, or a laser cleaning system.
